(19) United States
(12) Patent Application Publication
(10) Pub. No.: US 2014/0162006 A1
(43) Pub. Date: Jun. 12, 2014

(54) WATER-BLOWN PUR/PIR RIGID FOAM MATERIAL THAT CAN BE SPRAYED

(71) Applicants: Reinhard Albers, Leverkusen (DE); Patrick Klasen, Vettweiss (DE); Horst-Heinrich Schneider, Köln (DE); Stephanie Vogel, Langenfeld (DE)

(72) Inventors: Reinhard Albers, Leverkusen (DE); Patrick Klasen, Vettweiss (DE); Horst-Heinrich Schneider, Köln (DE); Stephanie Vogel, Langenfeld (DE)

(73) Assignee: Bayer Intellectual Property GmbH, Monheim (DE)

(21) Appl. No.: 14/233,413

(22) PCT Filed: Jul. 16, 2012
(86) PCT No.: PCT/EP2012/063903

§ 371 Date: Jan. 17, 2014

(30) Foreign Application Priority Data
Jul. 18, 2011 (DE) 10 2011 079 336.4

(51) Int. Cl. C08G 18/32; C08J 9/00

(52) U.S. Cl. CPC C08G 18/3221; C08J 9/00
USPC 428/36.5; 521/173; 521/115; 427/427.4; 427/427.5; 427/425

(57) ABSTRACT

The invention relates to a method for producing a water-blown polyurethane/polyisocyanurate rigid foam material that can be sprayed, by reacting a mixture comprising an aromatic polyester polyol, a first, comparatively short-chain aliphatic polyether polyol, a second, comparatively long-chain aliphatic polyether polyol, an isocyanate component, a blowing agent having water at least as a main component, and a catalyst component. The invention further relates to a rigid foam produced according to the method according to the invention, a composite material composed of said rigid foam and a pipe, and to the use of such a composite material for transporting liquid or gaseous media.

The present invention relates to a method of producing a rigid polyurethane-polyisocyanurate foam by reacting a mixture comprising an aromatic polyester polyol, a first, comparatively short-chain aliphatic polyether polyol, a second, comparatively long-chain aliphatic polyether polyol, an isocyanate component, a blowing agent component having water as main fraction at least and a catalyst component. The present invention further relates to a rigid foam obtained according to the method of the present invention, to a composite material combining this rigid foam and a pipe and also to the use of such a composite material for transporting liquid or gaseous media.

The oil and gas industry uses sprayable polyurethane systems to insulate pipes. The rigid PU-PIR foams thus obtained have to meet stringent requirements with regard to adherence, compressive strength and emissions while at the same time providing excellent insulating properties. Some of the physical blowing agents used will inevitably also escape into the environment during the spraying of polyurethane foams. Furthermore, the use of physical blowing agents is subject to statutory control with regard to their ODP and GWP classification and hence not equally possible in all countries. This does not apply to the use of water as blowing agent.

Sprayable systems should generally have an extremely short fiber time in order that excessive dripping or flowing may be avoided. This is achieved through appropriately high employment of catalysts and crosslinkers. However, embrittlement is a risk when excessively large amounts of catalyst and crosslinker are employed. The corresponding foams would have a sandy surface and composite materials would accordingly have very poor adherences to steel pipes for example. Water-blown rigid PU-PIR foams are generally known to be more likely to have a brittler foam structure than physically blown rigid foams because of the very high proportion of urea formed. The insulation performance of rigid PU-PIR foams is also worse because of the higher thermal conductivity of CO₂, and they are more prone to shrink.

It is predominantly rigid polyurethane foams which are currently produced by spraying. There are only a few sprayable PIR systems and even fewer sprayable PIR systems that use water as blowing agent. Polyether polyols are exclusively used on the polyol side of existing water-blown systems. The reason is the increasing brittleness of the PU-PIR foam on using polyester polyols. This holds for aromatic polyester polyols in particular.

The aforementioned conditions all lead to increasing embrittlement and hence to poor adherence properties on the part of rigid PU-PIR foams of this type.

The currently employed, customary procedure to counteract such brittleness and poor adherence of rigid PU-PIR foams is to increase the temperature of the support to which the foam is to adhere; to reduce the proportion of water in the formulation while at the same time the proportion of the physical blowing agent is increased; to increase the proportion of the PIR catalyst; and/or to use polyol of relatively high molecular weight on the polyol side or in the prepolymerized form of NCO prepolymers.

EP 1 632 511 A1 relates to rigid PU-PIR foams obtainable by reacting an organic polyisocyanate component with a polyol component comprising compounds having isocyanate-reactive hydrogen atoms to an isocyanate index of 100 to 400, more preferably 180 to 400, to produce rigid PU-PIR foams for laminates for example, in the presence of suitable auxiliary and added-substance materials and also blowing agents and co-blowing agents, wherein the polyol component comprises at least one aliphatic polyester polyol which in addition to structural units derived from adipic acid also contains structural units derived from glutaric acid, succinic acid or sebacic acid.

WO 2004/060950 A1 discloses a closed-cell foam from a mixture comprising a polyol component comprising an aromatic polyester polyol having an OH functionality of at least 2, a polyisocyanate in such a quantity that the isocyanate index is less than 350 and comprises a blowing agent component comprising water. The foam comprises cells having a mean diameter of about 160 micrometers (as measured by scanning electron microscopy) and the insulation R value of the aged foam is at least 4.5 R/inch.

EP 0 698 422 A1 describes a method of insulating pipes according to the composite principle, wherein a steel pipe has applied to it at least one layer of a polyisocyanurate plastic, then at least one layer of the rigid polyurethane foam and then a covering layer.

WO 02/40566 A2 relates to a prepolymer route. A method of producing a polyurethane-modified polyisocyanurate foam comprises reacting an at least bifunctional compound having active hydrogen atoms with a polyisocyanate compound in the presence of a catalyst and of a blowing agent comprising water alone or a mixture of water with a low-boiling blowing agent, wherein (1) the polyisocyanate compound is a prepolymer obtained from the reaction of polymeric MDI with 5% to 30% by weight, based on the polymeric MDI, and (2) the NCO index is at least 150.

A further example of a sprayed water-blown PIR foam comprising a specific polyether polyol is found in JP 2005-206819 A1. JP 2000-327741 A1 likewise concerns the use of a specific polyether polyol.

It is clear from the above that there continues to be a need for improved sprayable PU-PIR foams. The present invention accordingly has for its object to solve the problem of providing water-blown rigid PU-PIR foams in order that the emission of volatile, flammable and possibly environmentally harmful physical blowing agents may be avoided during spraying. The system should provide steel pipe adherences which are at least equivalent to the prior art and so be useful in the pipe manufacture for the oil and gas industry.

This object is achieved according to the present invention by a method of producing a rigid polyurethane-polyisocyanurate foam C from an isocyanate-reactive composition A and an isocyanate component B, wherein said isocyanate-reactive composition A comprises:
(i) an aromatic polyester polyol A1 having a hydroxyl number of ≧100 mg KOH/g to ≦350 mg KOH/g, an average OH functionality of ≧1.8 to ≦6.5,
(ii) an aliphatic polyether polyol A2a having a hydroxyl number of ≧150 mg KOH/g to ≦500 mg KOH/g, an average OH functionality of ≧1.5 to ≦5.5 and an ethylene oxide content of ≧0% by mass to ≦50% by mass, based on the overall mass of A2a, and
   a further aliphatic polyether polyol A2b having a hydroxyl number of ≧15 mg KOH/g to ≦150 mg KOH/g, an average OH functionality of ≧1.5 to ≦5.5 and an ethylene oxide content of ≧0% by mass to ≦50% by mass, based on the overall mass of A2b,
(iii) a blowing agent component A3 comprising water in a proportion of ≧90% by mass to ≦100% by mass, based on the overall mass of A3, and
(iv) a catalyst component A4 comprising a catalyst A4a to catalyze polyurethane formation and a catalyst A4b to catalyze polyisocyanurate formation.

It has now been found that, surprisingly, water-blown rigid PU-PIR foams having excellent adherence and insulation properties are obtainable in a conventional manner by the sprayed process through the appropriate combination of long- and short-chain polyether and polyester polyols with a suitable catalytic package. This is all the more surprising because this is wholly at odds with the aforementioned, hitherto customary procedure.

The polyols used will now first be described in more detail. Hydroxyl numbers mentioned can all be determined as described in German standard specification DIN 53240.

Examples of aromatic polyester polyols A1a are polycondensates formed from di- and also tri- and tetraols and di- and also tri- and tetracarboxylic acids or hydroxyl carboxylic acids or lactones.

Instead of free polycarboxylic acids, the corresponding polycarboxylic anhydrides or the corresponding polycarboxylic esters of lower alcohols can also be used to prepare the polyesters. Examples of suitable diols are ethylene glycol, butylene glycol, diethylene glycol, triethylene glycol, polyalkylene glycols such as polyethylene glycol, also 1,2-propanediol, 1,3-propanediol, 1,3-butanediol, 1,4-butanediol, 1,6-hexanediol and isomers, neopentylglycol or the neopentylglycol ester of hydroxypivalic acid. Polyols such as trimethylolpropane, glycerol, erythritol, pentaerythritol, trimethylolbenzene or trishydroxyethyl isocyanurate can also be used alongside these. Preference is given to using ethylene glycol and diethylene glycol.

Useful polycarboxylic acids include for example succinic acid, fumaric acid, maleic acid, maleic anhydride, glutaric acid, adipic acid, sebacic acid, 1,10-decanedicarboxylic acid, 1,12-dodecanedicarboxylic acid, phthalic acid, phthalic anhydride, isophthalic acid, terephthalic acid, pyromellitic acid, trimellitic acid or. Preference is given to using adipic acid and phthalic anhydride.

When the mean functionality of the polyol to be esterified is ≧2, monocarboxylic acids such as benzoic acid and hexanecarboxylic acid can also be used in addition.

Preferably, aromatic polyester polyol A1a has a hydroxyl number of ≧150 mg KOH/g to 340 mg KOH/g (more preferably ≧220 mg KOH/g to ≦260 mg KOH/g) and an average OH functionality of ≧1.8 to ≦3.0. Acid number is preferably in a range of ≧0.1 mg KOH/g to ≦5.0 mg KOH/g.

The hydroxyl numbers chosen according to the present invention characterize said aromatic polyester polyol A1a as a comparatively short-chain polyol having a mean molar mass of ≧200 g/mol to ≦2000 g/mol, preferably of ≧300 g/mol to ≦1500 g/mol and more preferably of ≧330 g/mol to ≦800 g/mol.

A preferred aromatic polyester polyol A1a is a polycondensation product of adipic acid, phthalic anhydride, diethylene glycol and/or ethylene glycol. Particularly preferred weight fractions for the reactants in the reaction mixture are as follows:

adipic acid: ≧7% by weight to ≦13% by weight;

phthalic anhydride: ≧37% by weight to ≦45% by weight;

diethylene glycol: ≧35% by weight to ≦43% by weight; and

ethylene glycol: ≧9% by weight to ≦15% by weight;

with the proviso that the particulars minus the water formed in the polycondensation reaction sum to ≦100% by weight.

Useful aliphatic polyether polyols A2a include, for example, polytetramethylene glycol polyethers such as obtainable by polymerization of tetrahydrofuran with cationic ring opening.

Useful polyether polyols further include addition products of styrene oxide, ethylene oxide, propylene oxide, butylene oxide and/or epichlorohydrin onto di- or polyfunctional starter molecules.

Suitable starter molecules include, for example, water, ethylene glycol, diethylene glycol, butyldiglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol and also low molecular weight hydroxyl-containing esters of such polyols with dicarboxylic acids.

Preferably, aliphatic polyether polyol A2a has a hydroxyl number of ≧200 mg KOH/g to 460 mg KOH/g (more preferably ≧400 mg KOH/g to ≦450 mg KOH/g) and average OH functionality of ≧1.8 to ≦3.5. The ethylene oxide content of this polyol is further preferably in the range ≧0% by mass to ≦15% by mass, based on the overall mass of A2a.

The hydroxyl numbers selected according to the present invention characterize the aliphatic polyether polyol A2a as a comparatively short-chain polyol.

A preferred aliphatic polyether polyol A2a is further obtained from the reaction of one or more sugar-containing starter molecules with propylene oxide.

Foam embrittlement due to the water in the polyol formulation would be expected. The formulation contains an unusual polyol for this technical field to counteract this. The same starting materials can be used in principle for this further aliphatic polyether polyol A2b as with polyether polyol A2a. Preferably, this polyether polyol A2b has a hydroxyl number of ≧20 mg KOH/g to 120 mg KOH/g (more preferably 25 mg KOH/g to ≦145 mg KOH/g) and average OH functionality of ≧1.8 to ≦3.5. The ethylene oxide content of this polyol is further preferably in the range ≧0% by mass to ≦40, based on the overall mass of A2b.

The hydroxyl numbers which are selected according to the present invention characterize said aliphatic polyether polyol A2b as a comparatively long-chain polyol.

A preferred further aliphatic polyether polyol A2b is obtained from the two-step reaction of one or more sugar-containing and/or glycol starter molecules with ethylene oxide and propylene oxide.

Since very fast fiber times are desired for sprayed applications, more than 50% of the OH groups in aliphatic polyether polyol A2b are preferably primary OH groups. It is particularly preferable for more than 80% or more than 90% of the OH groups in this polyol to be primary OH groups.

Examples of a suitable isocyanate component B are 1,4-butylene diisocyanate, 1,5-pentane diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′-and/or 2,4′-and/or 4,4′-diphenylmethane diisocyanate (MDI) and/or higher homologs (polymeric MDI), 1,3- and/or 1,4-bis-(2-isocyanatoprop-2-yl)benzene (TMXDI), 1,3-bis-(isocyanatomethyl)benzene (XDI), and also alkyl 2,6-diisocyanatohexanoates (lysine diisocyanates) with C₁ to C₆ alkyl groups.

In addition to the aforementioned polyisocyanates, modified diisocyanates of uretdione, isocyanurate, urethane, carbodiimide, uretoneimine, allophanate, biuret, amide, iminooxadiazinedione and/or oxadiazinetrione structure as well as unmodified polyisocyanate having more than 2 NCO groups per molecule such as, for example, 4-isocyanatomethyl-1,8-octane diisocyanate (nonane triisocyanate) or triphenylmethane 4,4′,4″-triisocyanate can also be used pro rata.

The isocyanate can be a prepolymer obtainable by reacting an isocyanate having an NCO functionality of ≧2 and polyols having a molecular weight of ≧62 g/mol to ≦8000 g/mol and OH functionalities of ≧1.5 to ≦6.

Blowing agent component A3 preferably comprises water in a proportion of ≧99% by mass to ≦100% by mass, based on the overall mass of A3. If at all necessary, co-blowing agents such as hydrocarbon blowing agents (especially n-pentane and cyclopentane), halogenated hydrocarbon blowing agents and haloalkane blowing agents can be used. The proportions contributed by blowing agent component A3 to isocyanate-reactive component A as a whole are suitably in particular ≧0.5% by weight to ≦10% by weight, preferably ≧10% by weight to ≦5% by weight and more preferably ≧1.5% by weight to ≦4% by weight.

With regard to catalyst component A4, examples of polyurethane catalyst A4a are aminic catalysts, particularly selected from the group triethylenediamine, N,N-dimethylcyclohexylamine, dicyclohexylmethylamine, tetramethylenediamine, 1-methyl-4-dimethylaminoethylpiperazine, triethylamine, tributylamine, dimethylbenzylamine, N,N′,N″-tris-(dimethylaminopropyl)hexahydrotriazine, tris-(dimethylaminopropyl)amine, tris(dimethylaminomethyl)phenol, dimethylaminopropylformamide, N,N,N′,N′-tetramethylethylenediamine, N,N,N′,N′-tetramethylbutanediamine, tetramethylhexanediamine, pentamethyldiethylenetriamine, pentamethyldipropylenetriamine, tetramethyldiaminoethyl ether, dimethylpiperazine, 1,2-dimethylimidazole, 1-azabicyclo[3.3.0]octane, bis-(dimethylaminopropyl)-urea, N-methylmorpholine, N-ethylmorpholine N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine and/or dimethylethanolamine.

Examples of polyisocyanurate catalyst A4b are tin compounds such as tin(II) acetate, tin(II) octoate, tin(II) ethylhexoate, tin(II) laurate, dibutyltin diacetate, dibutyltin dilaurate, dibutyltin maleate and/or dioctyltin diacetate, also nitrogen heterocycles such as tris-(N,N-dimethylaminopropyl)-s-hexahydrotriazine, hydroxides such as tetramethylammonium hydroxide and/or sodium hydroxide or carboxylic acid salts of an alkali metal such as sodium N-[(2-hydroxy-5-nonylphenyl)methyl]-N-methylaminoacetate, sodium acetate, sodium octoate, potassium acetate and/or potassium octoate or mixtures thereof.

Catalyst component A4 may comprise catalyst A4a in a proportion of 5% by mass to 50% by mass, for example, and catalyst A4b in a proportion of 95% by mass to 50% by mass, for example, all based on the overall mass of A4.

Isocyanate-reactive composition A may further comprise auxiliary and added-substance materials, for example:
(v) at least one foam stabilizer, preferably polyether siloxane, which generally is constructed as a copolymer from ethylene oxide and/or propylene oxide and is composite materials with a polydimethylsiloxane moiety, and
(vi) at least one flame retardant, preferably brominated and/or chlorinated polyols or phosphorus compounds (these types of flame retardants are described for example in “Kunststoffhandbuch”, Volume 7 “Polyurethanes”, Chapter 6.1; for example, the esters of orthophosphoric acid and of metaphosphoric acid, which each may likewise contain halogens; room temperature liquid flame retardants are preferably used).

The rigid PU-PIR foams of the present invention are preferably produced according to the single-step method known to a person skilled in the art, wherein the reaction components are continuously or batch reacted with each other and then cured in/on suitable molds/substrates. Examples are described in USA-A 2 764 565, in G. Oertel (ed.) “Kunststoff-Handbuch”, Volume VII, Carl Hanser Verlag, 3rd Edition, Munich 1993, pp. 267 ff., and also in K. Uhlig (ed.) “Polyurethan Taschenbuch”, Carl Hanser Verlag, 2nd Edition, Vienna 2001, pp. 83-102.

Further aspects and embodiments of the present invention are described hereinbelow. They can be combined in any desired manner unless the contrary is unambiguously apparent from the context.

In one embodiment, isocyanate-reactive composition A further comprises a crosslinker or chain extender A5 having an average functionality of ≧2 to ≦4 and a hydroxyl number (DIN 53240) of ≧600 mg KOH/g to ≦2000 mg KOH/g. Preferably, the OH number is ≧640 mg KOH/g to ≦700 mg KOH/g. This crosslinker can contain both OH and NH₂ or NH groups, in which case the OH number then logically includes the aminic hydrogen atoms. Preferred crosslinkers or chain extenders A5 are isophoronediamine, hexamethylenediamine, glycerol, butanediol, ethylene glycol, diethylene glycol, propylene glycol, ethylenediamine, ethanolamine, triethanolamine, trimethylolpropane and pentaerythritol. The crosslinker can be used to adjust the thixotropy of the reaction mixture to prevent dripping of a mixture which has been applied, but is still not fully cured. Suitable proportions of crosslinker A5 in isocyanate-reactive composition A are, for example, ≧1% by mass to ≦6% by mass, based on the overall mass of A.

In a further embodiment, blowing agent component A3 is free from hydrocarbon blowing agents, halogenated hydrocarbon blowing agents and haloalkane blowing agents. The term “free from” does not foreclose the presence of technically unavoidable traces of the blowing agents referred to. However, in this embodiment, none of these blowing agents are intentionally added.

In a further embodiment, the catalyst component comprises a tertiary amine, a carboxylic acid salt of an alkali metal, a salt of an N-[(2-hydroxy-5-alkylphenyl)alkyl]-N-alkylamino carboxylic acid and a bis(dialkylamino)alkyl ether. The preference here is for N,N-dimethylcyclohexylamine, potassium acetate, sodium N-[(2-hydroxy-5-nonylphenyl)methyl]-N-methylaminoacetate and bis(dimethylamino)ethyl ether.

In a further embodiment, the mass ratio of A1:(A2a+A2b) is between ≧1:1 and ≦6:1 and the mass fraction of the sum total of A1 and (A2+A2b) is between ≧70% by mass and ≦85% by mass, based on the overall mass of A. A mass ratio of 1.5:1 to ≦4:1 is preferred.

In a further embodiment, the mass ratio of A2a:A2b is between ≧0.3:1 and ≦3:1. A mass ratio of 0.5:1 to ≦2:1 is preferred.

In a further embodiment, isocyanate component B comprises at least one isocyanate selected from the group:

2,2′-methylenediphenyl diisocyanate, 2,4′-methylenediphenyl diisocyanate, 4,4′-methylenediphenyl diisocyanate, polynuclear methylenediphenyl diisocyanate, 2,4-tolylene diisocyanate, 2,6-tolylene diisocyanate, diisocyanatobenzene and/or naphthyl diisocyanate;

and/or isocyanate component B comprises:

at least one NCO-terminated prepolymer obtainable by reacting at least one of the aforementioned isocyanates with at least one polyol.

Polynuclear (polymeric) MDI is the preferred isocyanate. As far as the prepolymers are concerned, the polyols are preferably selected from aliphatic or aromatic polyether polyols each having 1 to 4 hydroxyl groups or aliphatic or aromatic polyester polyols each having a number-averaged molecular mass between ≧60 g/mol and ≦400 g/mol.

In a further embodiment, the isocyanate index (the molar ratio of NCO groups to NCO-reactive groups, multiplied by 100) is between ≧180 and ≦450. The isocyanate index is preferably ≧200 and ≦400 and more preferably ≧220 and ≦350.

In a further embodiment, isocyanate-reactive composition A and isocyanate component B are sprayed onto a substrate. This includes the case where a reaction mixture comprising A and B is sprayed onto the substrate. The temperature of the substrate surface at the time of spraying can be for example in a range of ≧20° C. to ≦70° C., preferably ≧30° C. to ≦60° C. After the foam has been applied by spraying and undergone curing, further layers can be applied to the foam. For example, a polyolefin cover layer can additionally be extruded onto a pipe thus treated.

Preferably, the substrate is a pipe composed of a material selected from the group consisting of: steel, stainless steel, copper, aluminum, plastic and concrete.

In a likewise preferred embodiment, the substrate is rotated during spraying. The particular advantage of the PU-PIR system of the present invention comes to bear here in that it can be adjusted so as not to drip. A pipe is conveniently rotated about its longitudinal axis, so the entire circumference of the pipe is reached by one static spray nozzle. It will be appreciated that the substrate, i.e., the tube for example, can also move linearly during spraying.

The present invention further provides a rigid polyurethane-polyisocyanurate foam obtainable according to a method of the present invention. The foam may for example have a density of ≧30 kg/m³ to ≦70 kg/m³, preferably ≧40 kg/m³ to ≦60 kg/m³. The density can be computed in a simplified method by determining the mass of a cube having an edge length of 10 cm.

In one embodiment, the rigid polyurethane-polyisocyanurate foam has a flame height of ≦150 mm in a DIN EN ISO 11925-2 fire test. Flame height is preferably ≦120 mm and more preferably ≦100 mm.

The invention likewise provides a pipe/rigid foam composite material obtainable by a method according to the present invention. The pipe/rigid foam composite material can simply be regarded as a pipe insulated by the foam of the present invention.

The invention finally also provides for the use of a pipe/rigid foam composite material according to the present invention to transport liquid or gaseous media. Steam in district heating applications, natural gas and petroleum oil are examples of such media.

### EXAMPLES

The present invention is further elucidated by the examples hereinbelow without, however, being limited thereto.

### GLOSSARY

polyol 1: aromatic polyester polyol having a hydroxyl number of 240 mg KOH/g (DIN 53240), an average OH functionality of 2 and a viscosity of 15 600 mPas at 20° C. (BMS AG). Polycondensation product of adipic acid, phthalic anhydride, diethylene glycol and ethylene glycol.
polyol 2: aromatic polyester polyol having a hydroxyl number of 210 mg KOH/g (DIN 53240), an average OH functionality of 2 and a viscosity of 10 450 mPas at 20° C. (BMS AG). Polycondensation product of adipic acid, phthalic anhydride and diethylene glycol.
polyol 3: polyether polyol having a hydroxyl number of 440 mg KOH/g (DIN 53240), an average OH functionality of 2.8 and a viscosity of 440 mPas at 25° C. (BMS AG). Obtained from the reaction of a sugar-containing and glycol-containing starter mixture with propylene oxide.
polyol 4: polyether polyol having a hydroxyl number of 28 mg KOH/g (DIN 53240), an average OH functionality of 2 and a viscosity of 860 mPas at 25° C. (BMS AG). Obtained from the two-step reaction of two or more glycol starter molecules with ethylene oxide and propylene oxide.
polyol 5: crosslinker having a hydroxyl number of 660 mg KOH/g (DIN 53240), an average functionality of 2 and a viscosity of 18 mPas at 20° C. (BMS AG)
TEP: triethyl phosphate, flame retardant (Lanxess AG)
Tegostab B 8461: foam stabilizer (Evonik)
Desmorapid 1792: N,N-dimethylaminocyclohexane catalyst (BMS AG)
Desmorapid 726b: potassium acetate catalyst (BMS AG)
Curithane 52: sodium N-[(2-hydroxy-5-nonylphenyl)methyl]-N-methylaminoacetate (Air Products)

Polycat 41: tris(dimethylaminopropyl)hexahydrotriazine catalyst (Air Products)
Niax Catalyst E-A-1: bis(dimethylamino)ethyl ether catalyst (Momentive)
isocyanate: polymeric MDI (Desmodur 44V20 L, BMS AG)

Production of PU-PIR Foams

The 2-component recipe made up of a polyol formulation and an isocyanate was processed via a sprayed process. The polyol formulation and the isocyanate were each initially charged at 35° C. The two components were combined via a high-pressure mixing head and sprayed onto a rotating pipe. The temperature at the surface of the rotating pipe was 50° C. The apparent densities reported were determined on a 1000 cm³ cube (10×10×10 cm) by determining the corresponding mass. The further test methods were: compressive strength (DIN EN 826), open-cell content (DIN ISO 4590-86), torsion (DIN EN ISO 6721-2), softening point (as per torsion test of DIN EN ISO 6721-2) and fire class (DIN EN ISO 111925-2). Subjective evaluations were made of the surface quality (on the scale of poor/moderate/good/very good) and of the adherence to the steel pipe (on the scale of poor/moderate/good/very good).

The results are reported in the table hereinbelow:

| | | Example | | |
|---|---|---|---|---|
| | | | | 3 |
| | | 1 | 2 | (comparator) |
| polyol 1 | parts by weight | 57 | 57 | — |
| polyol 2 | parts by weight | — | — | 57 |
| polyol 3 | parts by weight | 13 | 13 | 13 |
| polyol 4 | parts by weight | 13 | 13 | 13 |
| polyol 5 | parts by weight | 4.7 | 4.7 | — |
| TEP | parts by weight | 13 | 13 | 13 |
| water | parts by weight | 2.38 | 2.38 | 0.8 |
| Tegostab B8461 | parts by weight | 2 | 2 | 2 |
| Desmorapid 726b | parts by weight | 0.74 | 0.74 | — |
| Desmorapid 1792 | parts by weight | 1.50 | 2.50 | 1 |
| Curithane 52 | parts by weight | 3.96 | 3.96 | — |
| Niax Catalyst | parts by weight | 0.53 | 0.53 | — |
| E-A-1 | | | | |
| Polycat 41 | parts by weight | — | — | 0.5 |
| cyclopentane | parts by weight | — | — | 6 |
| isocyanate | parts by weight | 230 | 230 | 183 |
| index | NCO/OH | 260 | 256 | 320 |
| density | kg/m³ | 55 | 57 | 62 |
| surface quality | | moderate | good | good |
| compressive | MPa | 0.26 | 0.32 | 0.25 |
| strength axial | | | | |
| compressive | MPa | 0.36 | 0.45 | 0.53 |
| strength radial | | | | |
| open-cell content | % | 5 | 4 | 4 |
| softening point | ° C. | 255 | 260 | 225 |
| adherence | | good | very good | very good |
| fire class | | B2 | B2 | B2 |

The table shows two inventive recipes, which differ in the proportion of the PIR catalyst Desmorapid 1792. The softening point can be used to show that, as expected, the resultant PIR fraction is somewhat higher in Example 2 than in Example 1. This wholesale catalysis, then, surprisingly delivers an exceedingly homogeneous surface in Example 2.

Example 3 is a comparative example, representative of the current state of the art. An equivalent PU-PIR recipe was processed therein using the same sprayed technology, although in this case the physical blowing agent cyclopentane was used. The index is higher here compared with Examples 1 and 2. So the fact that the mechanical properties of the rigid PU-PIR foam as per Example 2 are similar to those of the foam as per Example 3 is all the more surprising. At the same time, the softening point in Comparative Example 3 is only 225° C., whereas the softening points of the two rigid PU-PIR foams as per Examples 1 and 2 do not occur before 255° C. and 260° C., respectively, despite the distinctly lower index.

1-15. (canceled)

16. A method of producing a rigid polyurethane-polyisocyanurate foam C from an isocyanate-reactive composition A and an isocyanate component B, wherein said isocyanate-reactive composition A comprises:
(i) an aromatic polyester polyol A1 having a hydroxyl number of ≧100 mg KOH/g to ≦350 mg KOH/g, an average OH functionality of ≧1.8 to ≦6.5,
(ii) an aliphatic polyether polyol A2a having a hydroxyl number of ≧150 mg KOH/g to ≦500 mg KOH/g, an average OH functionality of ≧1.5 to ≦5.5 and an ethylene oxide content of ≧0% by mass to ≦50% by mass, based on the overall mass of A2a, and
a further aliphatic polyether polyol A2b having a hydroxyl number of ≧15 mg KOH/g to ≦150 mg KOH/g, an average OH functionality of ≧1.5 to ≦5.5 and an ethylene oxide content of ≧0% by mass to ≦50% by mass, based on the overall mass of A2b,
(iii) a blowing agent component A3 comprising water in a proportion of ≧90% by mass to ≦100% by mass, based on the overall mass of A3, and
(iv) a catalyst component A4 comprising a catalyst A4a to catalyze polyurethane formation and a catalyst A4b to catalyze polyisocyanurate formation.

17. The method as claimed in claim 16, wherein said isocyanate-reactive composition A further comprises a crosslinker or chain extender A5 having an average functionality of ≧2 to ≦4 and a hydroxyl number of ≧600 mg KOH/g to ≦2000 mg KOH/g.

18. The method as claimed in claim 16, wherein said blowing agent component A3 is free from hydrocarbon blowing agents, halogenated hydrocarbon blowing agents and haloalkane blowing agents.

19. The method as claimed in claim 16, wherein the catalyst component comprises a tertiary amine, a carboxylic acid salt of an alkali metal, a salt of an N-[(2-hydroxy-5-alkylphenyl)alkyl]-N-alkylamino carboxylic acid and a bis(dialkylamino)alkyl ether.

20. The method as claimed in claim 16, wherein the mass ratio of A1:(A2a+A2b) is between ≧1:1 and ≦6:1 and the mass fraction of the sum total of A1 and (A2+A2b) is between ≧70% by mass and ≦85% by mass, based on the overall mass of A.

21. The method as claimed in claim 16, wherein the mass ratio of A2a:A2b is between ≧0.3:1 and ≦3:1.

22. The method as claimed in claim 16, wherein said isocyanate component B comprises at least one isocyanate selected from the group:
2,2′-methylenediphenyl diisocyanate, 2,4′-methylenediphenyl diisocyanate, 4,4′-methylenediphenyl diisocyanate, polynuclear methylenediphenyl diisocyanate, 2,4-tolylene diisocyanate, 2,6-tolylene diisocyanate, diisocyanatobenzene and/or naphthyl diisocyanate;
and/or said isocyanate component B comprises:
at least one NCO-terminated prepolymer obtainable by reacting at least one of the aforementioned isocyanates with at least one polyol.

23. The method as claimed in claim 16 wherein the isocyanate index is between ≧180 and ≦450.

24. The method as claimed in claim 16 wherein said isocyanate-reactive composition A and said isocyanate component B are sprayed onto a substrate.

25. The method as claimed in claim 24 wherein the substrate is a pipe composed of a material selected from the group consisting of: steel, stainless steel, copper, aluminum, plastic and concrete.

26. The method as claimed in claim 24 wherein the substrate is rotated during spraying.

27. A rigid polyurethane-polyisocyanurate foam obtainable according to the method as claimed in claim 16.

28. The rigid polyurethane-polyisocyanurate foam as claimed in claim 27 having a flame height of ≦150 mm in a DIN EN ISO 11925-2 fire test.

29. A pipe/rigid foam composite material obtainable by the method as claimed in claim 24.

30. A process to transport liquid or a gaseous media which comprises transporting the liquid or gaseous media through the pipe/rigid foam composite material as claimed in claim 29.
